(19) United States
(12) Patent Application Publication
(10) Pub. No.: US 2025/0347161 A1
(43) Pub. Date: Nov. 13, 2025

(54) GARAGE DOOR HINGE

(71) Applicant: Doggler Door, LLC, Laguna Niguel, CA (US)

(72) Inventor: Ronnie De La Rosa, Laguna Niguel, CA (US)

(21) Appl. No.: 19/201,679

(22) Filed: May 7, 2025

Related U.S. Application Data
(60) Provisional application No. 63/645,026, filed on May 9, 2024.

(51) Int. Cl. E05D 7/10; E05D 3/02

(52) U.S. Cl. CPC E05D 7/1061; E05D 3/02

(57) ABSTRACT

A sectional and side sectional garage door hinge and a method of using thereof is disclosed. The sectional and side sectional hinges may be attached to two garage door panels that are above each other and allow such garage door panels to latch and unlatch from each other. Each of the sectional and side sectional hinges may have an upper base attached to the upper garage door panel and a lower base attached to the lower garage door panel. The upper base and the lower base may have engagement members that latch and unlatch from each other. When the sectional and side sectional hinges are in the unlatched orientation, the two garage door panels may be separated from each other vertically to create an elevated opening between the garage door panels of the garage door.

### CROSS-REFERENCE TO RELATED APPLICATIONS

This application claims the benefits of provisional patent application Ser. No. 63/645,026, filed on 2024 May 9, the entire contents of which is expressly incorporated herein by reference.

### STATEMENT RE: FEDERALLY SPONSORED RESEARCH/DEVELOPMENT

Not Applicable

### BACKGROUND

The various aspects and embodiments described herein relate to a sectional garage door hinge and method of using thereof.

Many houses and condos have garages. The garage may be used to store vehicles and belongings of the household residents while also providing a space for activities. Garage doors are used to provide convenient access inside the garage and to also close down such access point when not in use. However, conventional garage doors and their components have certain deficiencies that may limit how a household resident may want to use the garage.

Accordingly, there is a need in the art for an improved device, system, and method for garage doors.

### BRIEF SUMMARY

The various embodiments and aspects disclosed herein address the needs discussed above, discussed below and those that are known in the art.

A sectional and side sectional garage door hinge and a method of using thereof is disclosed. The sectional and side sectional hinges may be attached to two horizontal garage door panels that are above each other and allow such garage door panels to latch and unlatch from each other. This allows one or more garage lower door panels to stay in the closed position while one or more of the upper garage door panels to be lifted up. Fresh air can enter and stale air can exit the garage while preventing pests from entering the garage from the ground and pets from getting out of the house.

Each of the sectional and side sectional hinges may have an upper base attached to the upper garage door panel and a lower base attached to the lower garage door panel. The upper base and the lower base may have engagement members that latch and unlatch from each other. When the sectional and side sectional hinges are in the unlatched orientation, the upper and lower garage door panels may be separated from each other vertically to create an elevated opening between the garage door panels of the garage door. The elevated opening may provide fresh air and outside lighting to the inside of the garage. Since the opening between the garage door panels is elevated and in between upper and lower panels, the lower garage door panels remain in the closed position and act as a barrier to prevent creatures and outside people from entering the garage. Additionally, the lower garage door panels may block the view of some of the things inside of the garage for outside observers, which such visual blockage may serve to provide the prevention of possible thefts of the things inside the garage. Also, pets cannot escape out of the garage with the utilization of the sectional and side sectional hinges disclosed herein.

More particularly, a garage door assembly is disclosed that may have a plurality of horizontal garage door panels including a first garage door panel and a second garage door panel stacked on top of each other in a closed position of the garage door assembly, at least two garage door tracks having a first garage door track and a second garage door track, the first and second garage door tracks being on opposite sides of the plurality of garage door panels, a garage door motor coupled to the plurality of horizontal garage door panels by a motor railing system, wherein each of the plurality of horizontal garage door panels are movable towards the garage door motor along the first and second garage door tracks, an emergency release configured to decouple the plurality of the horizontal garage door panels from the garage door motor and allow for manual movement of the plurality of horizontal garage door panels along the first and second garage door tracks, a garage door hinge having a first base configured to fasten to the first garage door panel and a second base configured to fasten to the second garage door panel, the first base having at least one fastening hole for securing the first base to the first garage door panel, the first base having a first engagement member of a latch, and the second base having at least one fastening hole for securing the second base to the second garage door panel, the second base having a second engagement member of the latch and a hinge for allowing pivotal motion between the first and second garage door panels when the first and second engagement members are engaged together, wherein the first and second engagement members of the latch are configured to disengage from each other to allow the first and second garage door panels to separate from each other and create an elevated opening between the plurality of horizontal garage door panels.

In some embodiments, the first base further has a roller carrier for a garage door roller that is configured to be movably coupled to the first garage door track. In some embodiments, the second base further has a second roller carrier for a second garage door roller that is configured to be movably coupled to the first garage door track.

In some embodiments, the second engagement member of the second base is attached to a pivoting plate of the hinge. In some embodiments, the pivoting plate of the hinge has a clearance hole configured to align with the at least one fastening hole of the first base.

In some embodiments, the first engagement member is a male latch and the second engagement member is a female latch. In some embodiments, the first engagement member is a protrusion body and the second engagement member is a rotatable receiving shell having a large opening connected to a small opening, the large opening being longer than the protrusion body.

Furthermore, a method of installing a sectional hinge to a garage door to allow for a creation of an elevated opening between a first garage door panel and a second garage door panel is disclosed that may include fastening a first base of the sectional hinge to the first garage door panel using at least one fastening hole of the first base, fastening a second base of the sectional hinge to the second garage door panel using at least one fastening hole of the second base, the first and second garage door panels stacked directly on top of each other when the garage door is in a closed position, and engaging a first engagement member of the first base with a second engagement member of the second base to allow for pivotal motion between the first and second garage door panels about a hinge on the second base, wherein the first and second engagement members are configured to disengage from each other to allow the first and second garage door panels to separate from each other and create the elevated opening therebetween.

In some embodiments, the second engagement member of the second base is attached to a pivoting plate of the hinge.

In some embodiments, the first engagement member is a male latch and the second engagement member is a female latch. In some embodiments, the engaging of the first engagement member with the second engagement member involves latching a protrusion that is on the first base inside of a shell that is attached to the second base. In some embodiments, the protrusion is inserted inside a large opening of the shell and the shell rotates to place the protrusion away from the large opening.

In some embodiments, the method further includes inserting a garage door roller inside a roller carrier of the first base.

Additionally, a garage door hinge assembly for detachably latching a first garage door panel to a second garage door panel of a garage door is disclosed that may have a first base having at least one fastening hole for securing the first base to the first garage door panel, the first base having a first engagement member of a latch, a second base having at least one fastening hole for securing the second base to the second garage door panel, the second base having a second engagement member of the latch and a hinge for allowing pivotal motion between the first and second garage door panels when the first and second engagement members are engaged together, wherein the first and second engagement members of the latch are configured to disengage from each other to allow the first garage door panel to traverse to an open position while the lower garage door panel remains in a closed position.

In some embodiments, the first base further has a roller carrier for a garage door roller. In some embodiments, the second base further has a second roller carrier for a second garage door roller.

In some embodiments, the second engagement member of the second base is attached to a pivoting plate of the hinge.

In some embodiments, the first engagement member is a male latch and the second engagement member is a female latch. In some embodiments, the first engagement member is a protrusion body and the second engagement member is a rotatable receiving shell having a large opening connected to a small opening, the large opening being longer than the protrusion body.

In some embodiments, the pivoting plate of the hinge has a clearance hole configured to align with the at least one fastening hole of the first base.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A shows a garage door assembly utilizing the sectional and side sectional hinges to create an elevated opening between the garage panels;

FIG. 1B shows the inside of the garage and the different components of the garage door assembly, including the sectional and side sectional hinges;

FIG. 2A illustrates one of the sectional hinges shown in FIG. 1B in the latched position;

FIG. 2B illustrates the sectional hinges shown in FIG. 2A in the unlatched orientation;

FIG. 3A illustrates one of the side sectional hinges shown in FIG. 1B in the latched position;

FIG. 3B illustrates the side sectional hinges shown in FIG. 3A in the unlatched orientation;

FIG. 4 shows the garage door assembly of FIG. 1B with the upper garage door panels separating from the lower garage door panels when the sectional and side sectional hinges are unlatched;

FIG. 5A shows a sectional hinge of FIG. 4 with its bases separated from each other;

FIG. 5B shows a side sectional hinge of FIG. 4 with its bases separated from each other;

FIG. 6A illustrates a perspective view of the sectional hinge shown in FIG. 2A;

FIG. 6B illustrates a perspective view of the sectional hinge with a latch handle in a disengaged position;

FIG. 6C illustrates a perspective view of the sectional hinge with the pivot portion pivoted away to disengage a upper base from a lower base;

FIG. 6D illustrates the upper base spread apart from the lower base;

FIG. 7A illustrates a sectional garage door hinge in the latched position and a latch handle in a biased engaged position.

FIG. 7B illustrates the sectional garage door hinge shown in FIG. 7A with a latch handle in a disengaged position;

FIG. 7C illustrates the sectional garage door hinge shown in FIG. 7A with a pivot portion pivoted away from an upper base so that the sectional garage door hinge is in an unlatched position;

FIG. 7D illustrates a front perspective exploded view of the sectional garage door hinge shown in FIG. 7A.

FIG. 7E illustrates a rear perspective exploded view of the sectional garage door hinge shown in FIG. 7A.

FIG. 8A illustrates a side sectional garage door hinge 1200 in the latched position and a latch handle in a biased engaged position.

FIG. 8B illustrates the side sectional garage door hinge shown in FIG. 7A with a latch handle in a disengaged position;

FIG. 8C illustrates the side sectional garage door hinge shown in FIG. 7A with a pivot portion pivoted away from an upper base so that the side sectional garage door hinge is in an unlatched position;

FIG. 8D illustrates a front perspective exploded view of the side sectional garage door hinge shown in FIG. 7A.

FIG. 8E illustrates a rear perspective exploded view of the side sectional garage door hinge shown in FIG. 7A.

### DETAILED DESCRIPTION

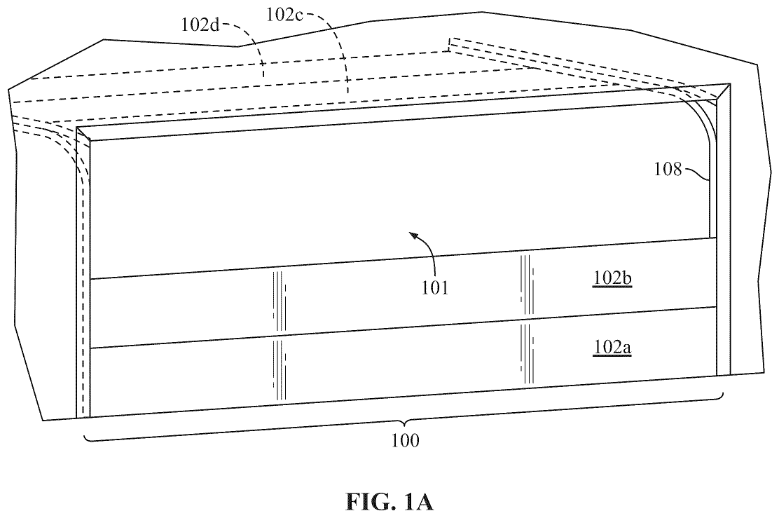

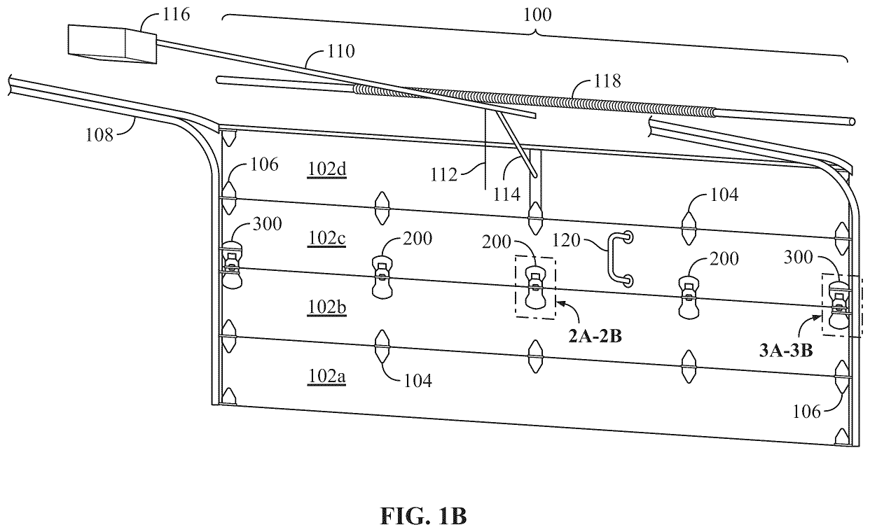

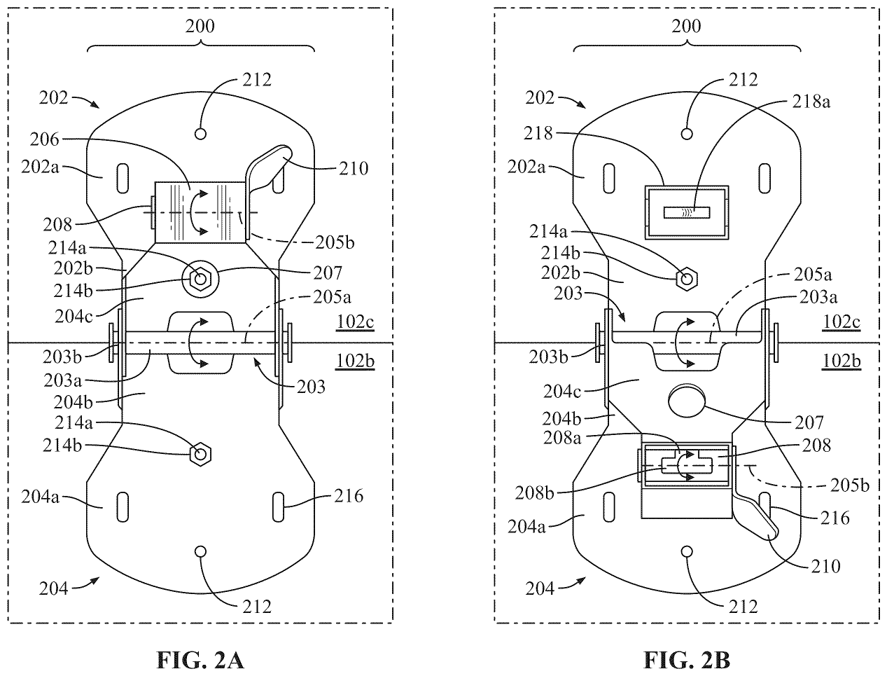

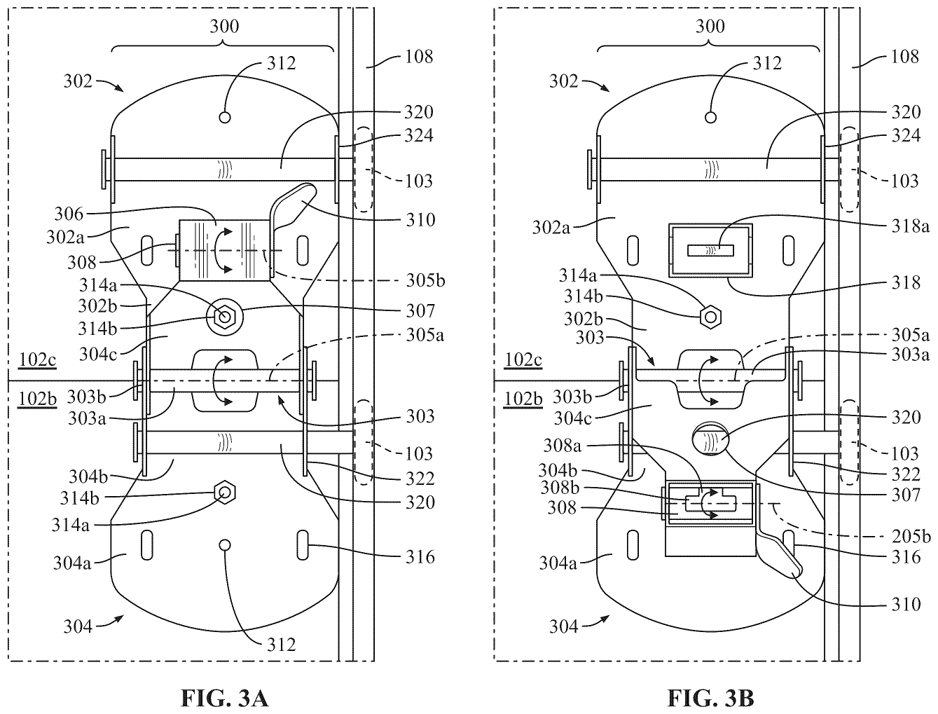

Various aspects of a garage door 100 are described herein. For example, a sectional and side sectional garage door hinges 200, 300 (see FIGS. 2A and 3A) and a method of using the same is discussed herein. Such hinge may be attached to two horizontal garage door panels 102b-c that are disposed one on top of the other when the garage door 100 is in the closed position (see FIG. 1B). The sectional hinges 200, 300 allow such garage door panels 102b-c to latch and unlatch from each other. This allows one or more lower garage door panels 102a-b to stay in the closed position while one or more of the upper garage door panels 102c-d can be lifted up so that an elevated opening 101 exists above the lower panels 102a-b. Fresh air can enter and stale air can exit the garage while preventing pests from entering the garage from the ground and pets from escaping out of the house through the garage.

Referring now to the figures, a sectional 200 and side sectional 300 garage door hinges (see FIGS. 2A and 3A) are disclosed that allow the upper garage panels 102c-d to separate from the lower garage panels 102a-b to create an elevated opening 101 (see FIG. 1A) in the garage door assembly 100. As shown in FIG. 1B, the sectional and side sectional hinges 200, 300 may be substituted for conventional garage door hinges 104, 106 between the garage door panels 102b-c that the user may create an elevated opening 101 therebetween. As shown in FIG. 2A, the sectional hinge 200 may have an upper base 202 that is fastened to an upper garage panel 102c and a lower base 204 that is fastened to a lower garage panel 102b. The lower base 204 may be unlatched from the upper base 202 (see FIG. 2B) to allow the two garage panels 102b-c to separate from each other to create the elevated opening 101, as shown in FIG. 1A. Similarly, the side sectional hinge 300 may have an upper base 302 (see FIG. 3A) that is fastened to an upper garage panel 102c and a lower base 304 that is fastened to a lower garage panel 102b. The lower base 304 may be unlatched from the upper base 302 (see FIG. 3B) to allow the two garage panels 102b-c to separate from each other to create the elevated opening 101, as shown in FIG. 1A. A user may utilize the features of the garage door assembly 100 (see FIG. 1A) to manually separate and reconnect the upper panels 102c-d from the lower panels 102a-b when the sectional and side sectional hinges 200, 300 are unlatched. Such mechanisms may include using the emergency release 112 that comes with garage doors. Additionally, a detachable handle 120 may be mounted to one of the upper panels 102c-d to help raise such panels towards the garage door motor 116 and create the elevated opening 101. Alternatively, the garage door motor 116 may be used to automatically separate and reconnect the upper panels 102c-d from the lower panels 102a-b when the sectional and side sectional hinges 200, 300 are unlatched.

Referring specifically now to Figures IA, a garage door assembly 100 is shown where the upper garage door panels 102c-d are detached from the lower garage door panels 102a-b and the upper panels are retracted upwards towards the garage door motor 116 (see FIG. 1B) to create an elevated opening 101. The elevated opening 101 may be used to provide air ventilation and outside light to the inside of the garage while the lower panels 102a-b, which are in their closed position, act as blocking structures. The blocking structure formed by the lower panels 102a-b may prevent outside creatures and pests from entering the garage and also block the view of some of the things and objects inside the garage.

The detachment of the upper panels 102c-d and lower panels 102a-b shown in FIG. 1A may be achieved by the usage of one or more sectional hinges 200 (see FIG. 2A) and side sectional hinges 300 (see FIG. 3A), as described elsewhere herein. The sectional hinges 200 and side sectional hinges 300 may couple to two horizontal garage door panels 102b-c, as shown in FIG. 1B, and have detachable parts that may be separated from each other to allow for the upper garage door panels 102c-d to separate from the lower garage door panels 102a-b and create the elevated opening 101. By way of example and not limitation, the sectional hinges 200 and side sectional hinges 300 may each have an upper base 202, 302 (see FIGS. 2A, 3A) attached to an upper garage panel (e.g., the third panel 102c in FIG. 1B) and a lower base 204, 304 attached to a lower garage panel (e.g., the second panel 102b in FIG. 1B), where the upper base 202, 302 may separate from the lower base 204, 304 when creating the elevated opening 101 (see FIG. 1A) between the panels of the garage door assembly 100. Although FIG. 1A shows the horizontal garage door panels separated from each other at the second and third panels 102b-c, it is contemplated herein that the sectional hinges 200 and side sectional hinges 300 may be used between other horizontal panels to create the elevated opening 101 at different heights (e.g., between first and second panels 102a-b or third and fourth panel 102c-d).

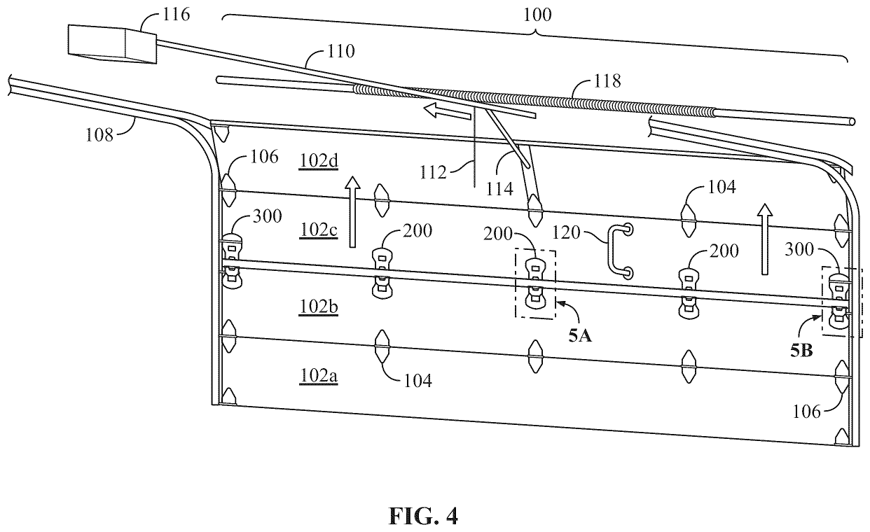

FIGS. 1B and 4 show the components of the garage door 100 from the inside of the garage and how the garage door 100 is transformed from its normal configuration (FIG. 1B) to having its upper panels 102c-d separated from the lower panels 102a-b (FIG. 4) using the sectional and side sectional hinges 200, 300 to create the elevated opening 101 (FIG. 1A). In FIG. 1B, the sectional and side sectional hinges 200, 300 may unlatch (see FIGS. 2B and 3B) to allow for the second and third panels 102b-c of the garage door 100 to separate from each other, as shown in FIG. 4. By way of example and not limitation, a user may utilize the mechanisms and components that are part of the garage door assembly 100 to separate the upper panels 102c-d from the lower panels 102a-b to create the elevated opening 101 (see FIG. 1A) when the hinges are unlatched.

By way of example and not limitation, the sectional hinge 200 may have an upper base 202 (see FIG. 2A) fastened to an upper panel 102c and a lower base 204 fastened to a lower panel 102b, where the upper base 202 is separable from the lower base 204. Similarly, and by way of example and not limitation, the side sectional hinge 300 may have an upper base 302 (see FIG. 3A) fastened to an upper panel 102c and a lower base 304 fastened to a lower panel 102b, where the upper base 302 is separable from the lower base 304. By way of example and not limitation, each lower base 204, 304 of the sectional and side sectional hinges 20, 300 may have a pivoting plate 204c, 304c that has an engagement member that engages a second engagement member on the upper base 202, 302. The pivoting plate 204c, 304c may rotate about an axis of rotation 205b, 305b of the hinge to engage and disengage with the upper base 202, 302. When all of the sectional and side sectional hinges 200, 300 attached to the panels 102b-c are unlatched, a user may separate the upper panels 102c-d from the lower panels 102a-b to create the elevated opening 101, as shown in FIG. 1A.

Referring back to FIG. 1B, and with further reference to FIG. 4, the upper panels 102c-d may be separated from the lower panels 102a-b using the emergency release 112 of the garage door assembly 100 to move the upper panels 102c-d towards the garage door motor 116 (see FIG. 4). When the emergency release 112 is active, the separated upper panels 102c-d may move freely along the sidetracks 108 of the garage door 100. The emergency release 112 may be designed to disengage the garage door panels from the motor belt/railing system 110 to allow for manual movement of the panels that are connected to the garage door arm 114. The emergency release 112 may be typically used during a power outage or an emergency, but also for the utilization of the sectional and side sectional hinges 200, 300. Such emergency disengagement and manual movement mechanism may be used when all the sectional and side sectional hinges 200, 300 are unlatched to create the elevated opening 101 between the panels (see FIG. 1A). The unlatched sectional and side sectional hinges 200, 300 may allow the separation between the panels 102b-c. The conventional garage door hinges 104, 106, which the side hinges 106 have garage rollers 103 to move through the sidetracks 108, keep the garage door panels connected to each other and allow the upper panels 102c-d to move together towards the garage door motor 116, and the lower panels 102a-b to stay stationary and stacked on top of each other. By way of example and not limitation, a detachable handle 120 may be mounted to one of the upper panels 102c-d and be used to move such panels towards the garage door motor 116 when the sectional and side sectional hinges 200, 300 are unlatched and the emergency release 112 is activated to disengage the panels from the garage door motor 116. When creating the elevated opening 101 between the panels, the garage torsion spring 118 (see FIG. 1B) may act as a counterbalance to the weight of the garage door panels to ensure such panels move steadily and with ease along the sidetracks 108. In another example, the garage door motor 116 may be actuated to separate and reconnect the upper panels 102c-d from the lower panels 102a-b when the sectional and side sectional hinges 200, 300 are unlatched.

Referring to FIGS. 2A-B, and by way of example and not limitation, the sectional hinge 200 may have two separatable bases 202, 204, where the upper base 202 may be fastened to an upper panel 102c and the lower base 204 may be fastened to the lower panel 102b. By way of example and not limitation, the upper base 202 may latch to the lower base 204 (see FIG. 2A) for normal operational use of the garage door assembly 100 (see FIG. 1B) where all of the panels are attached to each other to move to the open and closed position of the garage door. By way of example and not limitation, the upper base 202 may unlatch from the lower base 204 (see FIG. 2B) for separating the upper panels 102c-d from the lower panels 102a-b to create the elevated opening 101 (see FIG. 1A).

By way of example and not limitation, the upper base 202 of the sectional hinge 200 may be a metal plate body having a distal portion 202a and a proximal portion 202b (see FIG. 2B). By way of example and not limitation, the distal and proximal portions 202a-b of the upper base 202 may each have one or more fastening holes 212 for bolts 214a and nuts 214b to fasten the upper base 202 to an upper garage panel 102c. By way of example and not limitation, the upper base 202 of the sectional hinge 200 may also have a latch base 218 (see FIG. 2B) having a first engagement member. By way of example and not limitation, the first engagement member may be a cylindrical protrusion 218a (e.g., pin) that a rotatable receiving structure 208 on the lower base 204 may enclose and interlock with the protrusion 218a to latch the lower base 204 to the upper base 202, as described elsewhere herein. Consequently, the upper base 202 may have a male engagement member/latch (e.g., protrusion 218a) and the lower base 204 may have a female engagement member/latch (e.g., receiving structure 208). Alternatively, the upper base 202 may have the female engagement member/latch and the lower base 204 may have the male engagement member/latch. By way of example and not limitation, the latch base 218 and the first engagement member (e.g., protrusion 218a) may be located on the distal portion 202a or in between the boundary of the distal and proximal portions 202a-b of the upper base 202. Alternatively, the latch base 218 and the first engagement member may be located on the proximal portion 202b of the upper base 202. The position of the latch base 218 having the cylindrical protrusion 218a may be important for the case of the receiving structure 208 of the lower base 204 to latch on the protrusion 218. By way of example and not limitation, the distal portion 202a of the upper base 202 may have a greater planar thickness than the proximal portion 202b of the upper base 202. The greater planar thickness may make the upper base 202 sturdier and allow for adjustment holes 216. By way of example and not limitation, the distal portion 202a of the upper base 202 may also have adjustment holes 216 to the left and right sides of such portion, where a fastener attaching the upper base 202 to the upper garage panel 102c may slide within such holes and allow the upper base 202 to adjust vertically relative to the garage panel.

By way of example and not limitation, the lower base 204 may be a metal plate body having a distal portion 204a and a proximal portion 204b (see FIG. 2A). By way of example and not limitation, the distal and proximal portions 204a-b of the lower base 204 may each have one or more fastening holes 212 for bolts 214a and nuts 214b to fasten the lower base 204 to the lower garage panel 102b. By way of example and not limitation, the outer edge of the proximal portion 204b of the lower base 204, farthest from the distal portion 204a, may have a hinge mechanism 203 extending upwards therefrom. By way of example and not limitation, the hinge mechanism 203 of the lower base 204 of the sectional hinge 200 may have a cylindrical shell 203a extending between two side vertical frame structures 203b having holes to receive the ends cylindrical shell. By way of example and not limitation, the cylindrical shell 203a may be rotatably coupled to the holes of the two side vertical frames 203b. By way of example and not limitation, a pivoting portion 204c of the lower base 204 that is connected to the proximal portion 204b of the lower base 204 of the sectional hinge 200 may also be coupled to the two ends of the cylindrical shell 203a to make the hinge mechanism 203. When the lower base and the upper base are latched together, and by way of example and not limitation, the pivoting portion 204c may allow the upper panel 102c to pivot relative to the lower panel 102b, about an axis of rotation 205a extending along the length of the cylindrical shell 203a and allow the garage door assembly to function as originally designed.

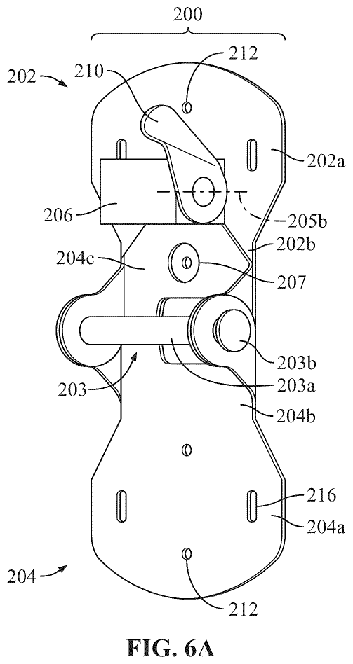

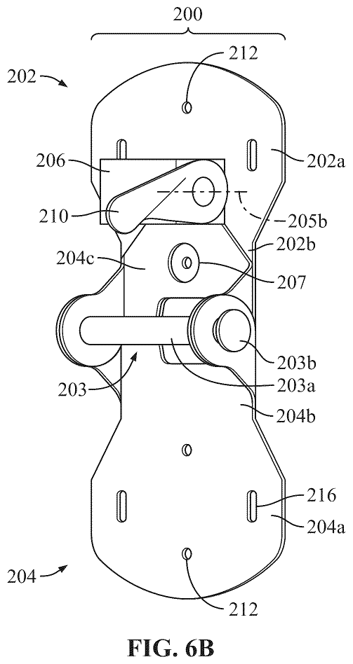

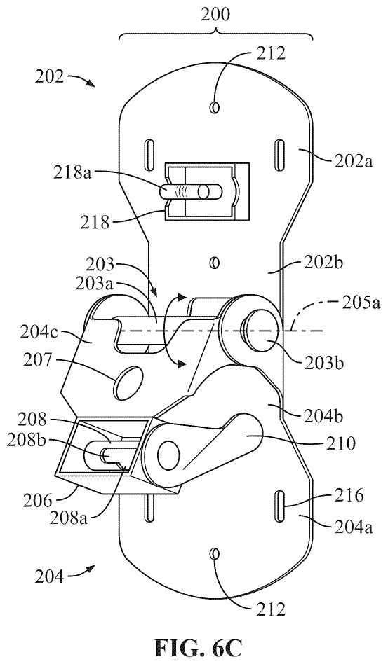

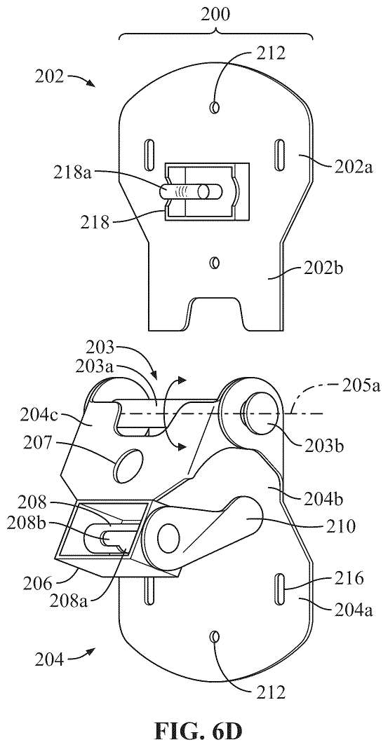

By way of example and not limitation, the end of the pivot portion 204c farthest away from the proximal portion 204b of the lower base 204 may have a second engagement member in the form of the receiving structure 208, which is rotatable inside a latch housing 206, to engage with the first engagement member (e.g., cylindrical protrusion 218a) of the upper base 202. As shown in FIGS. 6A-D, and described elsewhere herein, a latch handle 210 may rotate the receiving structure 208 inside the latch housing 206 about a rotational axis 205b to engage or disengage with the cylindrical pin 218 on the upper base 202 of the sectional hinge 200. By way of example and not limitation, the pivot portion 204c may have a clearance hole 207 that aligns with the fastening hole on the proximal portion 202b of the upper base 202 to allow the bolts 214a and nuts 214b to bypass the plate body of the pivot portion 204c and allow such plate body to lay flush on top of the upper base 202 for latching.

Referring back to FIG. 2A, and by way of example and not limitation, the distal portion 204a of the lower base 204 may have a greater planar thickness than the proximal 204b and the pivot portion 204c of the lower base 204 of the sectional hinge 200. The greater planar thickness may make the lower base 204 sturdier and allow for adjustment holes 216. By way of example and not limitation, the distal portion 204a of the lower base 204 may also have adjustment holes 216 to the left and right sides of such portion, where a fastener attaching the lower base 202 to the lower garage panel 102b may slide within such hole and allow the lower base 202 to adjust vertically relative to the panel. By way of example and not limitation, the sectional hinge 200 may be made from aluminum, steel, titanium, or other metal alloys.

Referring now to FIGS. 3A-B, the structural features of the side sectional hinge 300 are shown in latched and unlatched orientation, respectively. By way of example and not limitation, the side sectional hinge 300 may have similar structural features as the sectional hinge 200, as described elsewhere herein. As shown in FIGS. 3A-B, and by way of example and not limitation, the side sectional hinge 300 may have two separatable bases 302, 304, where the upper base 302 may be fastened to an upper garage panel 102c and the lower base 304 may be fastened to the lower garage panel 102b. By way of example and not limitation, the upper base 302 may engage and latch to the lower base 304 (see FIG. 3A) for normal operational use of the garage door assembly 100 (see FIG. 1B) where all of the garage door panels are attached to each other to move to the open and closed position together. By way of example and not limitation, the upper base 302 may disengage and unlatch from the lower base 304 (see FIG. 3B) for separating the upper garage panels from the lower garage panels to create the elevated opening 101 (see FIG. 1A). By way of example and not limitation, the upper base 302 and the lower base 304 may each have a roller carrier 320 for receiving a garage door roller 103. The garage door rollers 103 may be coupled to the sidetracks 108 of the garage door assembly 100 (see FIG. 1B) to move the garage door panels vertically. The garage door rollers 103 may be inserted inside the cylindrical shell of the roller carriers 320 of the side sectional hinge 300 cither leftward or rightwards, depending on what side of the garage door the side sectional hinge 300 is fastened.

The upper base 302 of the side sectional hinge 300 may be a metal plate body having a distal portion 302a and a proximal portion 302b (see FIG. 3B). By way of example and not limitation, the distal and proximal portion 302a-b of the upper base 302 may each have one or more fastening holes 312 for bolts 214a and nuts 214b to fasten the upper base 302 to the upper garage panel 102c. By way of example and not limitation, the upper base 302 of the side sectional hinge 300 may also have a latch base 318 (see FIG. 3B) having a first engagement member. 218 By way of example and not limitation, the first engagement member may be a cylindrical protrusion 318a (e.g., pin) that a receiving structure 308 on the lower base of the side sectional hinge (similar to the receiving structure 208 of the sectional hinge 200) may enclose around and interlock with the protrusion 318a to latch the lower base 304 to the upper base 402, as described elsewhere herein. Consequently, the upper base 302 may have a male engagement member/latch (e.g., protrusion 318a) and the lower base 304 may have a female engagement member/latch (e.g., receiving structure 308). Alternatively, the upper base 302 may have the female engagement member/latch and the lower base 304 may have the male engagement member/latch. By way of example and not limitation, the latch base 318 and the first engagement member (e.g., protrusion 318a) may be located on the distal portion 302a of the side sectional hinge 300 or in between the boundary of the distal and proximal portion 302a-b of the upper base 302. Alternatively, the latch base and the first engagement member may be located on the proximal portion 302b. The position of the latch base 318 may be important for the case of the receiving structure 308 of the lower base 304 to latch on the protrusion 318a of the latch base 318. By way of example and not limitation, the distal portion 302a of the upper base 302 may have a greater planar thickness than the proximal portion 302b of the upper base 302. The greater planar thickness may make the upper base sturdier and allow for adjustment holes 316. By way of example and not limitation, the distal portion 302a of the upper base 302 may also have adjustment holes 316 to the left and right sides of such portion, where a fastener attaching the upper base 302 to the garage door panel may slide within such holes and allow the upper base 302 to adjust vertically relative to the panel.

By way of example and not limitation, the upper base 302 of the side sectional hinge 300 may have a roller carrier 320 in the distal portion 302a. Alternatively, the roller carrier 320 may be in the proximal portion 302b of the upper base 302. By way of example and not limitation, the roller carrier 320 may be attached to two side frame plates 324 extending upwards from the left and right sides of the distal portion 302a, and the roller carrier 320 being a hollow cylindrical shell in between the frame plates 324. By way of example and not limitation, the roller carrier 320 may receive the garage door roller 103 either from the right or left end of the cylindrical shell, depending on which side of the garage door panel the side sectional hinge 300 is being attached thereto. Consequently, the upper garage panel 102c may roll upwards using the garage roller 103 to create the elevated opening 101 (see FIG. 1A) when the upper and lower bases 302, 304 are detached, and since the upper base 302 is fastened to the upper garage door panel 102c.

By way of example and not limitation, the lower base 304 of the side sectional hinge 300 may be a metal plate body having a distal portion 304a and a proximal portion 304b (see FIG. 3A). By way of example and not limitation, the distal and proximal portion 304a-b of the lower base 304 may each have one or more fastening holes 312 for bolts 214a and nuts 214b to fasten the lower base 304 to the lower garage panel 102b. By way of example and not limitation, the outer edge of the proximal portion 304b of the lower base 304, farthest from the distal portion 304a, may have a hinge mechanism 303 extending upwards therefrom. By way of example and not limitation, the hinge mechanism 303 may have a cylindrical shell 303a extending between two side vertical frame structures 303b having holes for the cylindrical shell 303a. By way of example and not limitation, the cylindrical shell 303a of the hinge mechanism 303 may be rotatably coupled to the two side vertical frames 303b of the hinge mechanism 303. By way of example and not limitation, a pivoting plate portion 304c of the lower base 304, which is connected to the proximal portion 304b of the lower base 304, may also be coupled to the two ends of the cylindrical shell 303a to make the hinge mechanism 303. By way of example and not limitation, when the lower base 304 and the upper base 302 are latched together, the pivoting portion 304c may allow the upper garage door panel 102c to pivot relative to the lower garage door panel 102b, about an axis of rotation 305a extending along the length of the cylindrical shell 303a of the hinge mechanism 303, and allow the garage door assembly 100 to function as originally designed.

By way of example and not limitation, the outer end of the pivot portion 304c farthest away from the proximal portion 304b of the lower base 304 may have a second engagement member in the form of the receiving structure 308 (similar to receiving structure 208 in FIG. 2B), which is rotatable inside a latch housing 306, to engage with the first engagement member (e.g., cylindrical protrusion 318 of FIG. 3B) of the upper base 302. As described elsewhere herein, and by way of example and not limitation, a latch handle 310 may rotate the receiving structure 308 inside the latch housing 306 about a rotational axis 305b to engage or disengage with the cylindrical pin 318 on the upper base 302 of the side sectional hinge 300. By way of example and not limitation, the pivot portion 304c may have a clearance hole 307 aligned with the fastening hole 312 of the proximal portion 302b of the upper base 302 to allow the bolts 214a and nuts 214b to bypass the plate body of the pivot portion 304c and allow such plate body to lay flush on top of the upper base 302 for latching.

By way of example and not limitation, the lower base 304 of the side sectional hinge 300 may have a roller carrier 320 behind the hinge mechanism 303 and in the proximal section 304b of the lower base 304. Alternatively, the roller carrier 320 may be on the distal portion 304a of the lower base 304. By way of example and not limitation, the roller carrier 320 may be similar to the roller carrier of the upper base 302 of the side sectional hinge 300 and be coupled to two side frame plates 322. By way of example and not limitation, the two side frame plates 322 having the roller carrier 320 may be unitarily formed with the two side vertical frames 303b of the hinge mechanism 303. By way of example and not limitation, the two side frame plates 322 having the roller carrier 320 may extend rearwards and at an upward incline from the two side vertical frames 303b of the hinge mechanism 303. By way of example and not limitation, the roller carrier 322 of the lower base 304 may be a hollow cylindrical shell between the side frames 322 and configured to receive the garage door roller 103, the hollow cylindrical shell being behind the cylindrical shell 303a of the hinge mechanism 303. Consequently, the lower garage door panel 102b may stay coupled to the sidetracks 108 of the garage assembly 100 (see FIG. 1B) when the upper panel 102c is separated from the lower garage door panel 102b when creating the elevated opening 101. The lower garage door panel 102b may also roll upwards easily during the normal function of the garage door assembly 100 with the addition of an extra roller carrier 320 for the side sectional hinge 300.

By way of example and not limitation, the side frames 322 of the roller carrier 320 of the lower base 304 may also be higher and incline upwards from the hinge mechanism 303 and its side frames 303b towards the roller carrier 320. This may be so to give the hinge mechanism 303 extra space when the upper panel 102c pivots relative to the lower panel 102b during normal operational use of the garage assembly (i.e., all of the panels of the garage door moving upwards and downwards together). The height of the roller carrier side frames 322 and the inclined slope may differ for different side sectional hinges depending on what two garage door panels the side sectional hinge 300 is configured to fasten and allow for pivoting. Such change in incline and height may be needed for the necessary spacing when the upper panel 102c pivots relative to the lower panel 102b. By way of example and not limitation, a side sectional hinge 300 designed to fasten to an upper garage door panel, such as panels 102c-d of FIG. 1B, may have a larger change in height and incline between the roller carrier 320 of the lower base 304 and the hinge mechanism 303 when compared to a side sectional hinge designed to fasten lower garage door panels relative to the upper panels of the garage door.

Referring back to FIG. 3A, and by way of example and not limitation, the distal portion 304a of the lower base 304 of the side sectional hinge 300 may have a greater planar thickness than the proximal 304b and pivot portion 304c of the lower base 304. The greater planar thickness may make the lower base 304 sturdier and allow for adjustment holes 316. By way of example and not limitation, the distal portion 304a of the lower base 304 of the side sectional hinge 300 may also have adjustment holes 316 to the left and right sides of such portion. A fastener attaching the lower base 304 to the lower garage door panel 102b may slide within such holes and allow the lower base 304 to adjust vertically relative to the garage door panel. By way of example and not limitation, the side sectional hinge 300 may be made from aluminum, steel, titanium, or other metal alloys.

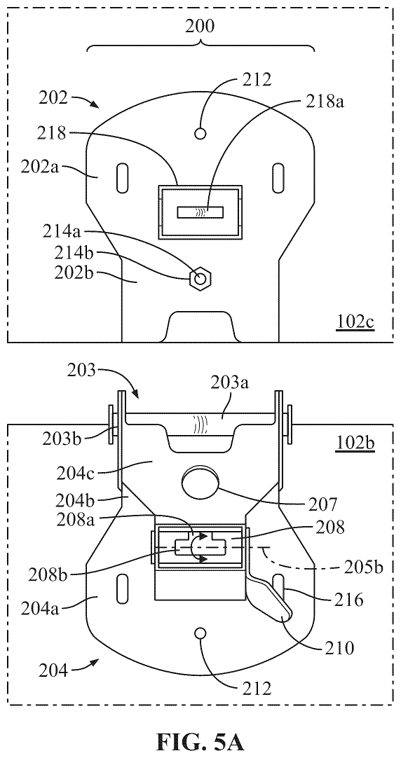

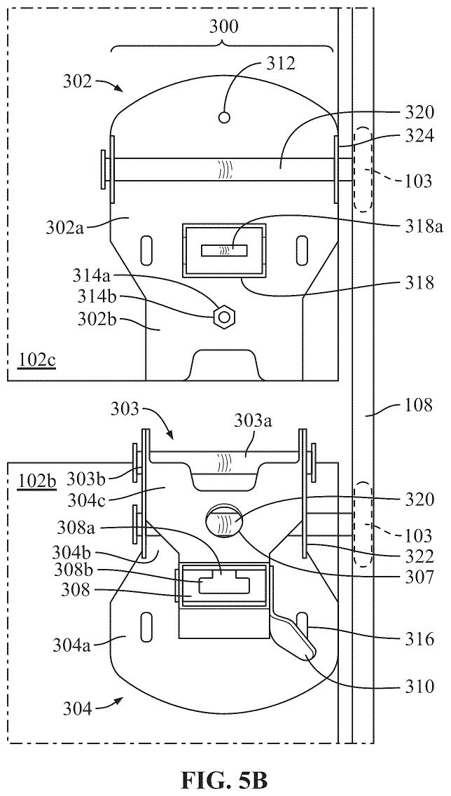

Referring now to FIGS. 6A-D, the unlatching of the lower base 204 from the upper base 202 of the sectional hinge 200 is shown. The lower base 204 may be re-latched to the upper base 202 by the reversal of the steps shown in FIGS. 6A-C and described elsewhere herein. By way of example and not limitation, the same unlatching and latching mechanism shown in FIGS. 6A-D may also apply to the side sectional hinge 300 (see FIGS. 3A-B). The unlatching and latching mechanism described herein with respect to the protrusion 218a and the receiving structure 208 of the sectional hinge 200 shown in FIGS. 6A-D may also apply to the protrusion 318a and receiving structure 308 of the side sectional hinge 300 (see FIGS. 3B and 5B). The small and large openings 308a-b of the receiving structure 308, the latch housing and handle 306, 310 of the side sectional hinge 300 may be the same and function as what is being described with the latching and unlatching of the sectional hinge 200 herein and with respect to FIGS. 6A-D. The latching and unlatching between the upper and lower bases of the sectional and side sectional hinges 200, 300 are not limited to the specific latching mechanism described herein. Other latching mechanisms are also contemplated herein, such as any latching mechanism that has a first and second engagement member.

By way of example and not limitation, the latching mechanism may work with the receiving structure 208 engaging and disengaging with the cylindrical protrusion 218a of the latch base 218. Consequently, the upper base 202 may have a male engagement member/latch (e.g., protrusion 218a) and the lower base 204 may have a female engagement member/latch (e.g., receiving structure 208). Alternatively, the upper base 202 may have the female engagement member/latch and the lower base 204 may have the male engagement member/latch. By way of example and not limitation, the receiving structure 208 may be a cylindrical shell rotatable inside the latch housing 206 (see FIG. 6A), the receiving structure having a large opening 208b and a small opening 208a that are connected to each other. By way of example and not limitation, the inside of the cylindrical shell of the receiving structure 208 may be large enough to store the cylindrical protrusion 218a of the latch base 218. By way of example and not limitation, the cylindrical protrusion 218a may be inserted inside the cylindrical shell through the large opening 208b of the receiving structure 208, the large opening 208b being longer than the protrusion 218a. The cylindrical protrusion 218a may be locked inside the receiving structure 208 by rotating the large opening 208b away from the cylindrical protrusion 218a. This may be done by using the latch handle 210 to rotate the receiving structure inside the latch housing 206 about an axis of rotation 205b, extending along the length of the receiving structure inside the latch housing 206, such that the cylindrical protrusion 218a is aligned and located within the small opening 208a of the receiving structure 208. The small opening 208a of the receiving structure 208 may be shorter than the length of the cylindrical protrusion 218a such that these components cannot detach from each other without the receiving structure 208 being rotated to align the cylindrical protrusion 218a with the large opening 208b.

By way of example and not limitation, FIG. 6A shows the latch handle 210 coupled to the receiving structure 208 inside of the latch housing 206 being at an upward position when the protrusion 218a is locked inside the receiving structure 208. The protrusion 218a may be within the small opening 208a of the receiving structure 208 in the locked position. Alternatively, the upward position of the latch handle 210 may correspond to the unlocked position between the protrusion 218a and the receiving structure 208. By way of example and not limitation, FIG. 6B shows how the latch handle 210 is turned downwards to rotate the receiving structure 208 within the latch housing 206 such that the protrusion 218a of the latch base 218 faces and is within the large opening 208b of the receiving structure 208. By way of example and not limitation, FIG. 6C shows how the protrusion 218a of the latch base 218 may be detached from the receiving structure 208 through the large opening 208b and unlatch the lower base 204 from the upper base 202. The pivot portion 204c of the lower base 204 may now be rotated towards the lower base 204 so that the bases may detach from each other to initialize the creation of the elevated opening 101 (see FIG. 1A). As shown in FIG. 6D, the upper base 202 of the sectional hinge 200 may separate from the lower base 204 when the engagement members of the two bases 202, 204 are disengaged.

By way of example and not limitation, the re-latching of the lower base 204 from the upper base 202 may be done by the reversal of what is shown in FIGS. 6A-C and described elsewhere herein. The latching description pertaining to FIGS. 6A-C may also apply to the side sectional hinge 300 shown in FIGS. 3A-B. Alternatively, the upper base 202 may have the rotatable receiving structure 208 and the pivot portion 204c and the lower base 204 may have the cylindrical protrusion 218a used for locking the bases 202, 204.

When the sectional and side sectional hinges 200, 300 are unlatched using the features and steps described elsewhere, then the upper panels 102c-d may be manually separated from each other (see FIGS. 4 and 5A-B) using the emergency release mechanism 112 of the garage door assembly 100 or automatically with the usage of the garage door motor 116, described elsewhere herein. Consequently, an elevated opening 101 may be created (see FIG. 1A) between the upper panels 102c-d and lower panels 102a-b to allow fresh air and outside light to enter the garage while preventing outside creatures from getting inside. Also, the view from someone looking inside the garage is partially blocked since the opening 101 is elevated, which helps prevent some of the objects inside the garage from being seen. By way of example and not limitation, a detachable handle 120 may be attached to one of the upper panels 102c-d to move such panels upwards towards the garage door motor 116 when the emergency release 112 is activated and the panels may move manually along the sidetracks 108. Alternatively, the garage door motor 116 may be used to actuate the upper panels 102c-d away from the lower panels 102a-b to create the elevated opening 101.

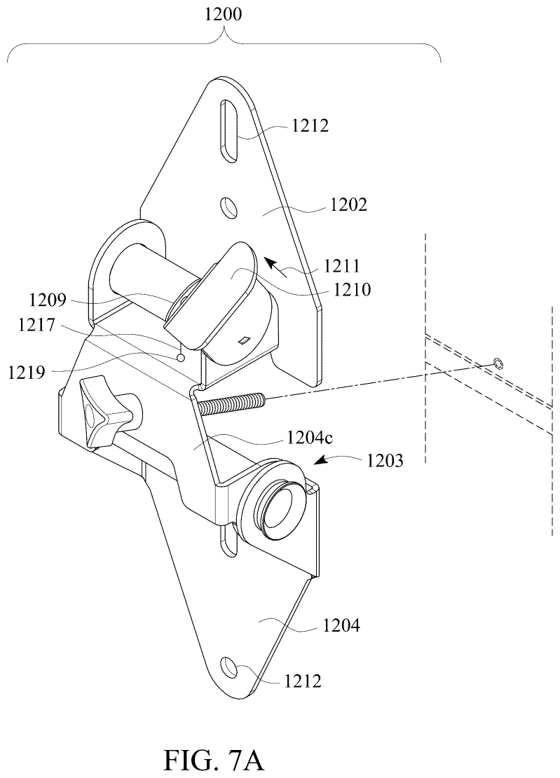

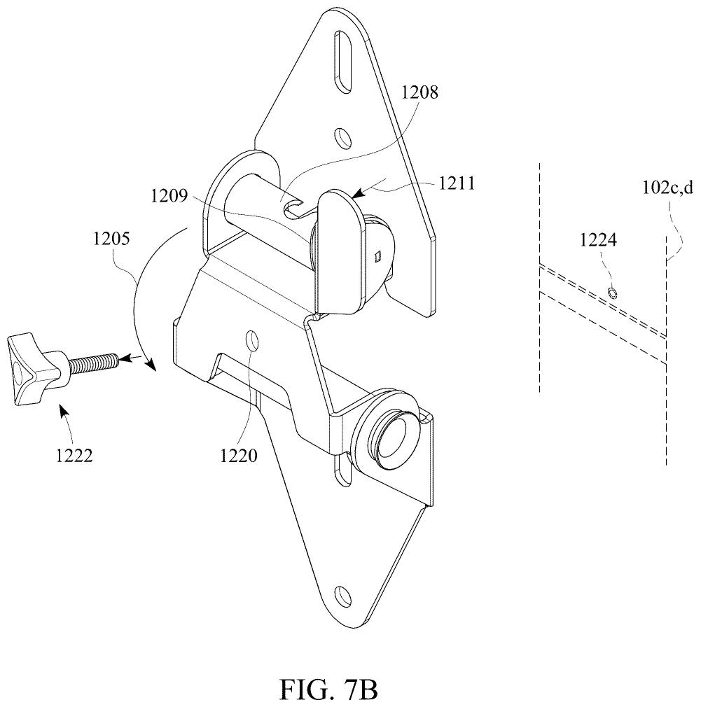

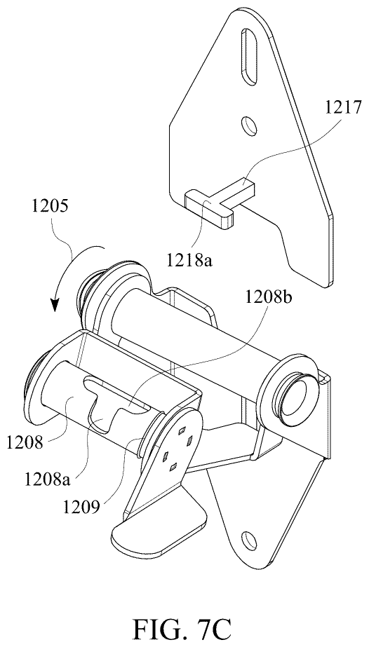

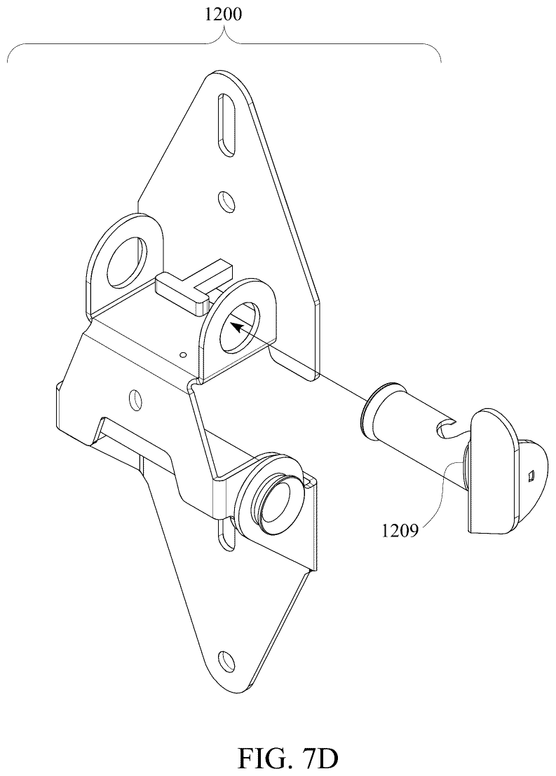

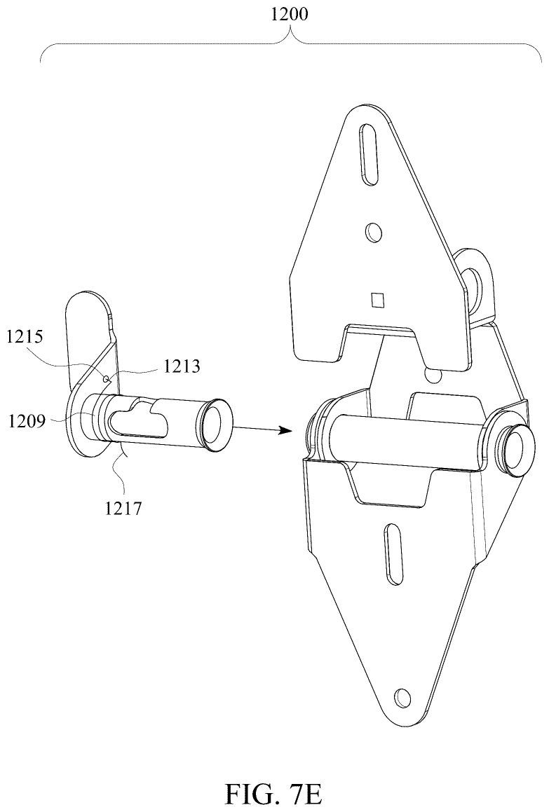

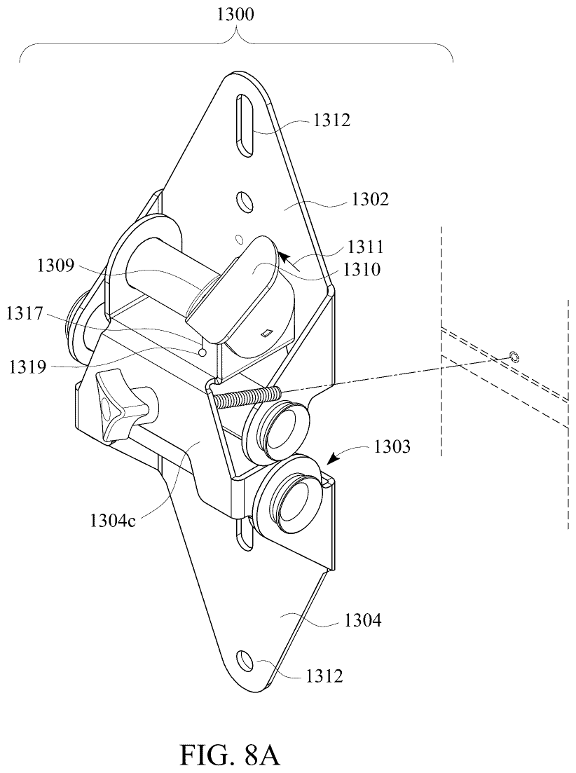

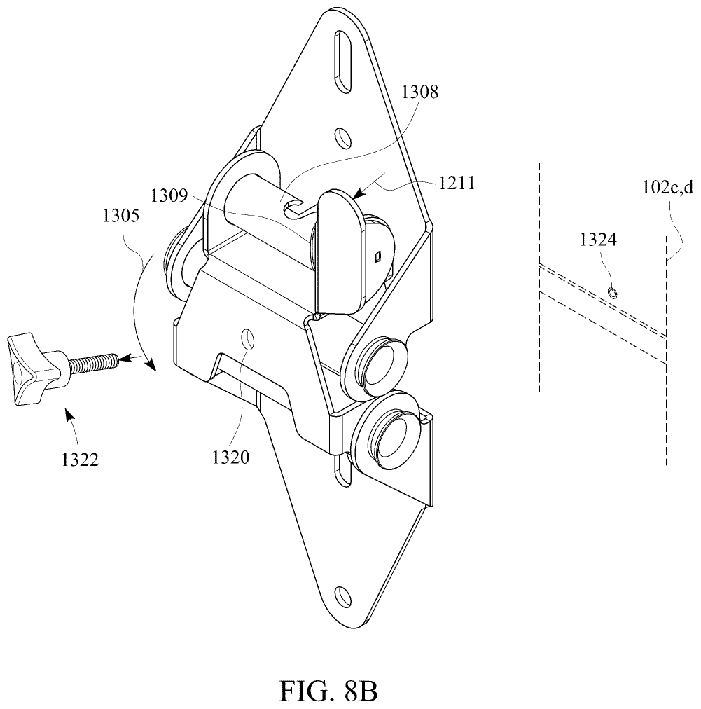

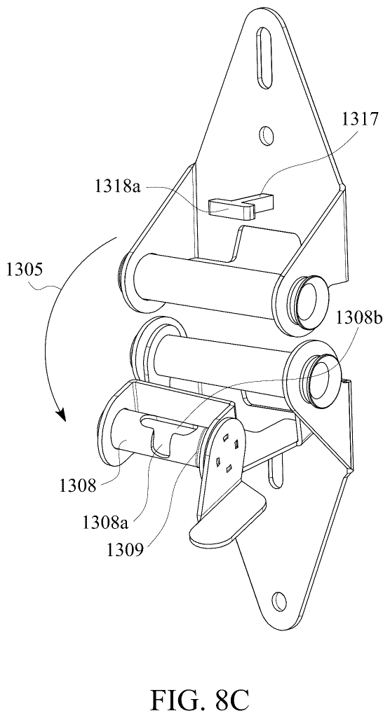

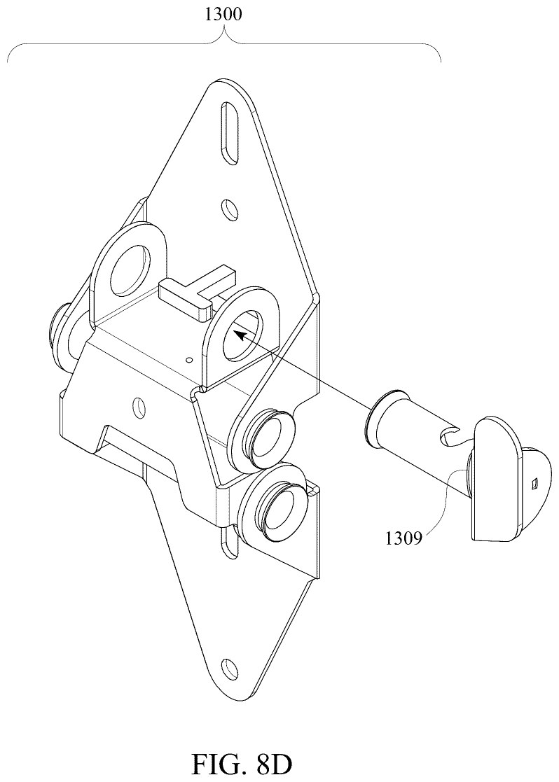

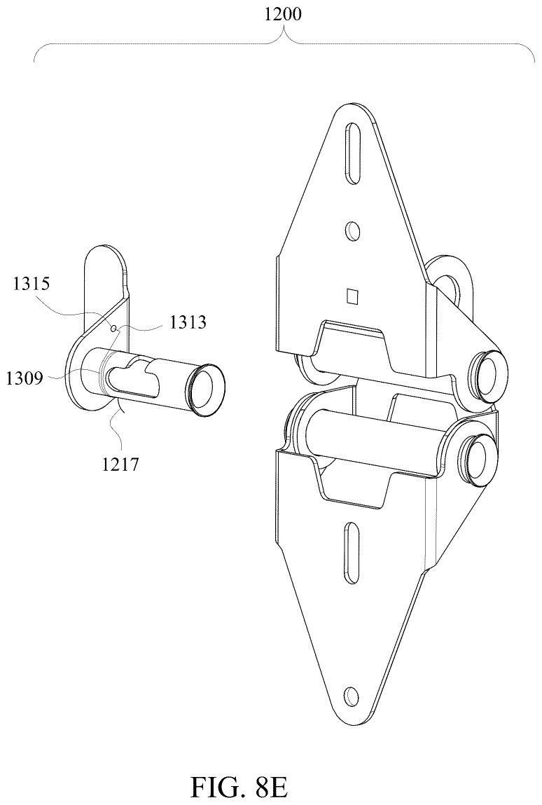

Referring now to FIGS. 7A to 8E, and by way of example and not limitation, sectional hinges 1200 and 1300 are disclosed. The sectional hinges 1200 and 1300 are structurally similar to the sectional and side sectional hinges 200 and 300 discussed elsewhere herein except for the following differences. The parts shown in FIGS. 7A-8E have been identified with similar numberings as those in FIGS. 1-6D. For the same part. 1000 was added to the part number for the part shown in FIGS. 7A-8E.

FIGS. 7A-7E illustrate various views of the sectional hinge 1200, while FIGS. 8A-8E illustrate various views of the side sectional hinge 1300. FIGS. 7A and 8A show the sectional hinges 1200 and 1300 in a latched orientation with the latch handles 1210 and 1310 in the biased engaged position. FIGS. 7B and 8B show the latch handles 1210 and 1310 rotated upward to a disengaged position, allowing movement of the pivot portions 1204c and 1304c relative to the upper bases 1202 and 1302. FIGS. 7C and 8C show the pivot portions 1204c and 1304c pivoted away from the upper bases 1202 and 1302 to unlatch the sectional hinges 1200 and 1300. FIGS. 7D-7E and 8D-8E show front and rear perspective exploded views of the sectional hinges 1200 and 1300, respectively.

By way of example and not limitation, the upper bases 1202 and 1302 have a triangular outer configuration compared to the bulbous outer configuration of the upper bases 202 and 302 shown in FIGS. 2A and 3A. Additionally, unlike hinges 200 and 300, the hinges 1200 and 1300 do not have latch housings 206, 306 or latch bases 218, 318.

By way of example and not limitation, to operate the sectional hinges 1200 and 1300 from the locked position shown in FIGS. 7A and 8A, a user pushes upward on the latch handles 1210 and 1310, respectively, as shown by arrows 1211 and 1311. This overcomes the spring force due to the torsion spring as discussed below. This action rotates the latch handles 1210, 1310 about axes of rotation that cause the receiving structures 1208 and 1308 (see FIGS. 7B and 8B) to rotate. At the end of the rotation, the large openings 1208b and 1308b of the receiving structures are aligned with the protrusions 1218a and 1318a extending from the pivot portions 1204c and 1304c. These protrusions 1218a, 1318a do not need to be cylindrical but can have a bar configuration.

When the large openings 1208b and 1308b are aligned with the cylindrical protrusions 1218a and 1318a, the pivot portions 1204c and 1304c can be rotated away from the upper bases 1202 and 1302, as shown in FIGS. 7C and 8C. Before the latch handles are rotated, the stems 1217 and 1317 of the torsion springs 1209 and 1309 are disposed within the small openings 1208a and 1308a, preventing the pivot portions 1204c and 1304c from moving away from the upper bases 1202 and 1302.

By way of example and not limitation, to pivot the pivot portions 1204c and 1304c away from the upper bases 1202 and 1302 and toward the lower bases 1204 and 1304, the user pivots the pivot portions in the direction of arrows 1205 and 1305. This action separates the upper garage door panels 102c-d from the lower garage door panels 102a-b and creates an elevated opening between the panels, similar to what is shown and described in relation to FIGS. 1A and 4.

The latch handles 1210 and 1310 are biased towards the engaged position shown in FIGS. 7A and 8A by way of torsion springs 1209 and 1309. One end 1213 and 1313 of the torsion spring is fastened to the latch handle 1210 and 1310, respectively, via apertures 1215 and 1315. The opposite ends of the torsion springs 1217 and 1317 are fastened to the upper bases 1202 and 1302 via apertures 1219 and 1319, respectively. The torsion springs 1209 and 1309 thereby urge the latch handles 1210 and 1310 into the biased engaged position, ensuring engagement of the locking mechanism when the garage door is closed and opened.

Upon disengagement of the latch mechanism as shown in FIGS. 7C and 8C, the upper garage door panels 102c-d may be manually separated from the lower garage door panels 102a-b by using the emergency release mechanism 112 (see FIG. 1B) or through operation of the garage door motor 116.

Referring now to the procedure for re-engagement of the sectional hinges 1200 and 1300, and by way of example and not limitation, the user manually moves the upper garage door panels 102c-d downward adjacent to the lower garage door panels 102a-b. To re-engage the panels together, the pivot portions 1204c and 1304c are rotated back toward the upper bases 1202 and 1302. The cylindrical protrusions 1218a and 1318a are inserted into the large openings 1208b and 1308b of the receiving structures 1208 and 1308. The spring then rotates the latch handles 1210 and 1310 downward such that the receiving structures 1208 and 1308 rotate so that the protrusions 1218a, 1318a are caught within the receiving structures 1208, 1308.

The misalignment secures the protrusions 1218a and 1318a within the receiving structures 1208 and 1308, thereby locking the pivot portions 1204c and 1304c against movement and reconnecting the upper garage door panels 102c-d to the lower garage door panels 102a-b. The torsion springs 1209 and 1309 automatically bias the latch handles 1210 and 1310 into the locked engaged position to ensure secure connection during normal garage door operation.

Consequently, the sectional hinges 1200 and 1300 disclosed in FIGS. 7A-8E provide alternative sectional and side sectional hinge configurations that maintain the functionality described herein while having aesthetic and mechanical variations compared to the sectional and side sectional hinges 200 and 300.

By way of example and not limitation, the pivoting portions 1204c and 1304c of the sectional hinges 1200 and 1300 may include an optional or alternative attachment mechanism to further secure the upper bases 1202 and 1302 to the pivoting portions during use. Each pivoting portion 1204c and 1304c may have a hole 1220, 1320, respectively, formed therethrough. A bolt 1222, 1322 may be inserted through the hole 1220, 1320 from below and threaded into a rivet nut 1224, 1324 that is attached to the exterior face of the upper garage door panel 102c or 102d. The rivet nuts 1224 and 1324 may be crimped, press-fitted, or otherwise securely fastened into a pre-drilled hole in the panel to provide internal threading. The bolt 1222, 1322 may have a head that is tightenable or loosenable by hand. The bolt 1222, 1322 may be retained on the pivoting portions 1204c, 1304c when disengaged to the riv-nut 1224, 1324.

The bolt-and-riv-nut attachment structure may be used in addition to the spring-biased latch handle mechanism described elsewhere herein, or it may serve as an alternative means of securing the upper and lower bases together in embodiments where a mechanical fastener is preferred for added security or simplicity of manufacture.

In operation, and by way of example and not limitation, the method of engaging the sectional hinges 1200 and 1300 using the bolt attachment involves first aligning the pivoting portion 1204c, 1304c with the upper base 1202, 1302 such that the cylindrical protrusion 1218a, 1318a is positioned within the receiving structure 1208, 1308. Once aligned, the bolt 1222, 1322 is inserted upward through the hole 1220, 1320 of the pivoting portion and threaded into the riv nut 1224, 1324 to secure the hinge in the engaged position. The user may tighten the bolt 1222, 1322 until the pivoting portion lies flush against the upper base 1202, 1302. This method may be used independently or in conjunction with the latch handle 1210, 1310.

To disengage the hinge using this method, the user first unthreads and removes the bolt 1222, 1322 from the riv nut 1224, 1324. With the bolt removed but yet still retained on the pivoting portions, the latch handle 1210, 1310 may then be rotated to align the large opening 1208b, 1308b with the cylindrical protrusion 1218a, 1318a. The pivoting portion 1204c, 1304c may then be rotated downward to separate the lower base from the upper base, thereby allowing the upper garage door panels 102c-d to move independently from the lower panels 102a-b.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A garage door assembly, comprising:
a plurality of horizontal garage door panels including a first garage door panel and a second garage door panel stacked on top of each other in a closed position of the garage door assembly;
at least two garage door tracks having a first garage door track and a second garage door track, the first and second garage door tracks being on opposite sides of the plurality of garage door panels;
a garage door motor coupled to the plurality of horizontal garage door panels by a motor railing system, wherein each of the plurality of horizontal garage door panels are movable towards the garage door motor along the first and second garage door tracks;
an emergency release configured to decouple the plurality of the horizontal garage door panels from the garage door motor and allow for manual movement of the plurality of horizontal garage door panels along the first and second garage door tracks;
a garage door hinge having a first base configured to fasten to the first garage door panel and a second base configured to fasten to the second garage door panel;
the first base having at least one fastening hole for securing the first base to the first garage door panel, the first base having a first engagement member of a latch; and
the second base having at least one fastening hole for securing the second base to the second garage door panel, the second base having a second engagement member of the latch and a hinge for allowing pivotal motion between the first and second garage door panels when the first and second engagement members are engaged together;
wherein the first and second engagement members of the latch are configured to disengage from each other to allow the first and second garage door panels to separate from each other and create an elevated opening between the plurality of horizontal garage door panels.

2. The garage door assembly of claim 1, wherein the first base further comprises a roller carrier for a garage door roller that is configured to be movably coupled to the first garage door track.

3. The garage door assembly of claim 2, wherein the second base further comprises a second roller carrier for a second garage door roller that is configured to be movably coupled to the first garage door track.

4. The garage door assembly of claim 1, wherein the second engagement member of the second base is attached to a pivoting plate of the hinge.

5. The garage door assembly of claim 1, wherein the first engagement member is a male latch and the second engagement member is a female latch.

6. The garage door assembly of claim 5, wherein the first engagement member is a protrusion body and the second engagement member is a rotatable receiving shell having a large opening connected to a small opening, the large opening being longer than the protrusion body.

7. The garage door assembly of claim 4, wherein the pivoting plate of the hinge has a clearance hole configured to align with the at least one fastening hole of the first base.

8. A method of installing a sectional hinge to a garage door to allow for a creation of an elevated opening between a first garage door panel and a second garage door panel, comprising:
fastening a first base of the sectional hinge to the first garage door panel using at least one fastening hole of the first base;
fastening a second base of the sectional hinge to the second garage door panel using at least one fastening hole of the second base, the first and second garage door panels stacked directly on top of each other when the garage door is in a closed position; and
engaging a first engagement member of the first base with a second engagement member of the second base to allow for pivotal motion between the first and second garage door panels about a hinge on the second base;
wherein the first and second engagement members are configured to disengage from each other to allow the first and second garage door panels to separate from each other and create the elevated opening therebetween.

9. The method of claim 8, wherein the second engagement member of the second base is attached to a pivoting plate of the hinge.

10. The method of claim 8, wherein the first engagement member is a male latch and the second engagement member is a female latch.

11. The method of claim 8, wherein the engaging of the first engagement member with the second engagement member involves latching a protrusion that is on the first base inside of a shell that is attached to the second base.

12. The method of claim 11, wherein the protrusion is inserted inside a large opening of the shell and the shell rotates to place the protrusion away from the large opening.

13. The method of claim 8, further comprising inserting a garage door roller inside a roller carrier of the first base.

14. A garage door hinge assembly for detachably latching a first garage door panel to a second garage door panel of a garage door, comprising:
a first base having at least one fastening hole for securing the first base to the first garage door panel, the first base having a first engagement member of a latch; and
a second base having at least one fastening hole for securing the second base to the second garage door panel, the second base having a second engagement member of the latch and a hinge for allowing pivotal motion between the first and second garage door panels when the first and second engagement members are engaged together;
wherein the first and second engagement members of the latch are configured to disengage from each other to allow the first garage door panel to traverse to an open position while the lower garage door panel remains in a closed position.

15. The garage door hinge assembly of claim 14, wherein the first base further comprises a roller carrier for a garage door roller.

16. The garage door hinge assembly of claim 15, wherein the second base further comprises a second roller carrier for a second garage door roller.

17. The garage door hinge assembly of claim 14, wherein the second engagement member of the second base is attached to a pivoting plate of the hinge.

18. The garage door hinge assembly of claim 14, wherein the first engagement member is a male latch and the second engagement member is a female latch.

19. The garage door hinge assembly of claim 14, wherein the first engagement member is a protrusion body and the second engagement member is a rotatable receiving shell having a large opening connected to a small opening, the large opening being longer than the protrusion body.

20. The garage door hinge assembly of claim 17, wherein the pivoting plate of the hinge has a clearance hole configured to align with the at least one fastening hole of the first base.
